(19) United States
(12) Patent Application Publication
(10) Pub. No.: US 2008/0106890 A1
(43) Pub. Date: May 8, 2008

(54) Illumination apparatus adaptable to pet collars

(76) Inventor: John Sowakinas, Allendale, NJ (US)

Correspondence Address: JAMES RAY & ASSOCIATES, 2640 PITCAIRN ROAD, MONROEVILLE, PA, 15146, US

(21) Appl. No.: 11/983,097

(22) Filed: Nov. 7, 2007

Related U.S. Application Data
(60) Provisional application No. 60/864,842, filed on Nov. 8, 2006.

(51) Int. Cl. A01K 27/00; F21V 21/08

(52) U.S. Cl. 362/103

(57) ABSTRACT

A lighting apparatus adaptable to pet collars and leashes includes a main body housing at least one light source, at least one on/off switch, and at least one battery. A substantially rigid strip with two ends in a first plane about 180 degrees apart with a central portion bowed away from the first plane is secured to the main body with a pivot mechanism that allows aiming of the lights at selectable angles. At least two straps or clips removably retain the rigid strip to the outer side of a collar or leash.

### CROSS REFERENCE TO RELATED APPLICATION

This patent application is related to and claims priority from U.S. Provisional Patent Application Ser. No. 60/864,842 filed Nov. 8, 2006.

### FIELD OF THE INVENTION

The present invention relates, in general, to accessories for pet collars and leashes, and, more particularly, this invention relates to improved illumination of pets and the walking path ahead of the animal.

### BACKGROUND OF THE INVENTION

Prior to the conception and development of the present invention, many devices have been offered for making pets more noticeable in the dark. Dog collars with one or more lights imbedded or attached are readily available, in blinking, glowing, or constant forms of lighting, such as those sold at www.coolsafetyproducts.com. These are typically only for the purpose of making the dog more visible to approaching cars or for finding a dog in dark areas. Details of such are provided in U.S. Pat. Nos. 5,535,106, 5,630,382, and 6,892,678.

The concept of hanging lights from animals to light a path ahead goes back at least as far as U.S. Pat. No. 743,578, which disclosed how to hang a lantern to shine in front of a horse. The utility of such lighting has been recognized for making walking in dark conditions safer for both the animals and the people involved.

U.S. Pat. No. 6,805,460 discloses a dog collar light that can attach to common collars essentially flush with the outer surface of the collar. While this device can light the path ahead of the animal, it provides only one light, and the angle of that light's beam is not readily adjustable. Furthermore, the light may be obstructed by heavy fur or the dog lowering its head.

### SUMMARY OF THE INVENTION

The present invention provides a lighting apparatus adaptable to pet collars and leashes, and includes a main body housing at least one light, at least one on/off switch, and at least one battery. A substantially rigid strip with two ends in a first plane about 180 degrees apart with a central portion bowed away from the first plane is secured to the main body with a pivot mechanism that allows aiming of the lights at selectable angles. At least two straps or clips removably retain the rigid strip to the outer side of a collar or leash.

### OBJECTS OF THE INVENTION

It is, therefore, one of the primary objects of the present invention to provide safer conditions for night-time walking of pets.

Another object of the present invention is to provide adjustable illumination of a dog and the path ahead of a dog being walked in dark conditions so that hazards can be avoided.

Still another object of the present invention is to provide a lighting device adaptable to common collar, harnesses, and leashes that can be aimed in numerous directions.

Yet another object of the present invention is to make the pet and the one walking it more visible to approaching motorists.

An additional object of the present invention is to provide an inexpensive lighting unit for pet collars that can be employed in pairs, each unit independently adjustable thus providing lighting over a wide area ahead of and to the side of the pet.

In addition to the various objects and advantages of the present invention described with some degree of specificity above, it should be obvious that additional objects and advantages of the present invention will become more readily apparent to those persons who are skilled in the relevant art from the following more detailed description of the invention, particularly, when such description is taken in conjunction with the attached drawing figures and with the appended claims.

### BRIEF DESCRIPTION OF THE DRAWINGS

FIG. 1 is a perspective view of the illumination apparatus attached to a pet collar.

FIG. 2 is a perspective view illustrating the use of the invention on a dog's collar and the leash.

FIG. 3 provides a perspective view of the underside of the light apparatus with additional details.

### DETAILED DESCRIPTION OF A PRESENTLY PREFERRED EMBODIMENT OF THE INVENTION

Prior to proceeding to the more detailed description of the present invention it should be noted that, for the sake of clarity and understanding, identical components which have identical functions have been identified with identical reference numerals throughout the several views illustrated in the drawing figures.

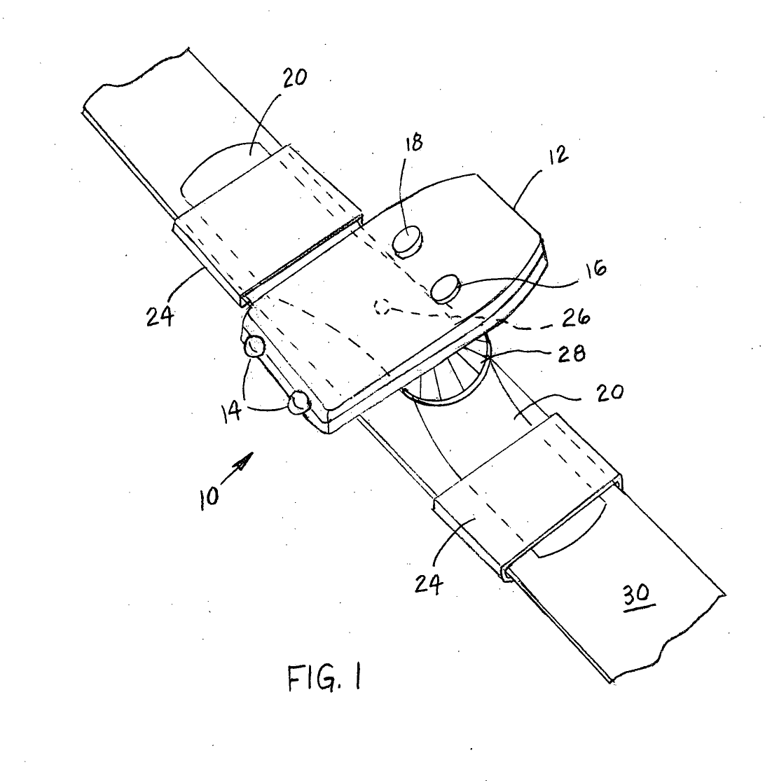

Referring initially to FIG. 1, the lighting apparatus 10 is shown attached to a pet collar 30, which can be any standard leather or fabric collar. The light housing 12 includes two LED lights on one edge that can be turned on by switch 16 and off by switch 18. Numerous other arrangements of lights and switches would also be acceptable. A removable or rechargeable battery is enclosed within, but not shown here; and, it is wired in typical fashion to the lights 14 and switches 16 and 18. Clips or Velcro® straps 24 hold the two legs of the mounting strip 20 against the collar 30. The somewhat rigid mounting strip 20, made of metal or plastic, is bowed substantially outward away from the collar 30. Testing has shown that this is necessary to ensure unobstructed light rays when put on medium and long-haired pets. The angle of the lights rays can be adjusted by swiveling the light housing 12 on a pivot pin 26 that rotatably secures the light housing 12 to the mounting strip 20. It can be held in the desired position by friction such as by detents, or a rough surface on the swivel base 28 and on the underside of light housing 12.

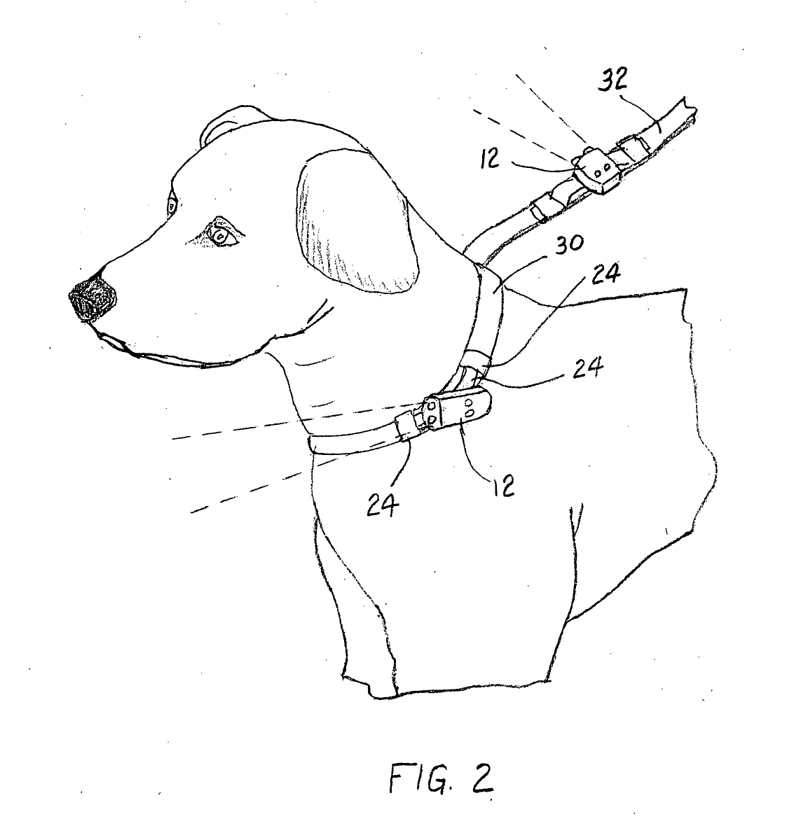

FIG. 2 depicts the invention in use on a dog's collar 30 and the leash 32. The light housing 12 is held to the collar 30 by straps 24 that secure the mounting strip 20 to the collar 30. The present invention can be readily installed and removed. The mounting strip 20 is bowed out to hold the light housing 12 away from the dog's body. If desired, an illumination apparatus 12 can be attached to the leash 32 to provide warning to side-approaching vehicles, or to aid the owner in cleaning up the dog's feces. The light housings 12 can be swiveled to aim the light beams as desired. It may be preferable to have a light mounted on each side of the dog with each of the two aimed at a different angle so as to provide near and far lighting of the path ahead.

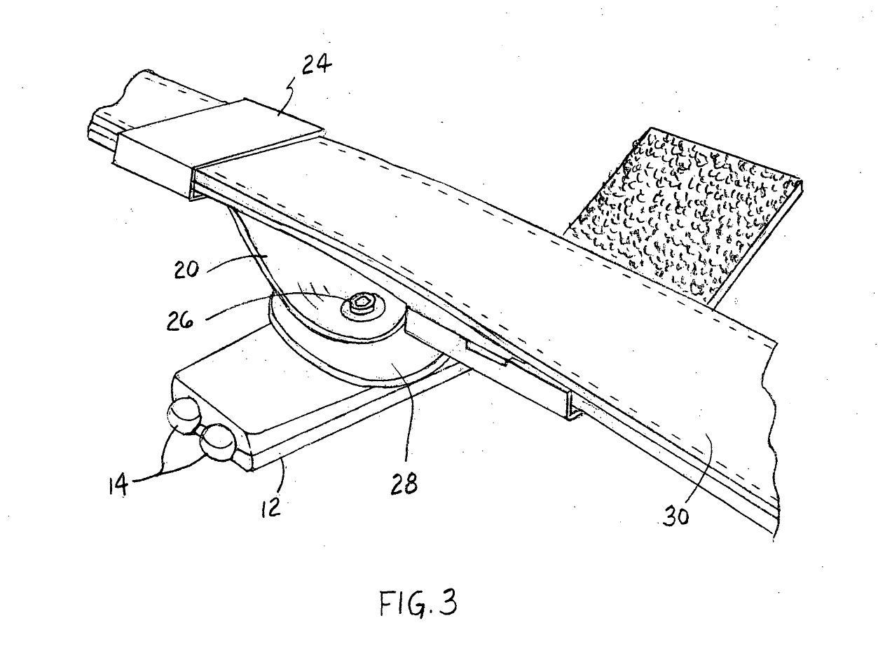

FIG. 3 is a perspective view of the underside showing additional details. The mounting strip 20 is held to the collar 30 by clips or preferably Velcro® straps 24, but the mounting strip 20 is bowed out significantly at the center to hold the light housing 12 substantially out from the collar 30. The pivot pin 26 and swivel base 28 provide a mechanism for aiming the lights 14. The pivot pin 26 could be a rivet or a nut and bolt. A wing nut may be preferable to make it easy to adjust and tighten in position.

While a presently preferred and various alternative embodiments of the present invention have been described in sufficient detail above to enable a person skilled in the relevant art to make and use the same, it should be obvious that various other adaptations and modifications can be envisioned by those persons skilled in such art without departing from either the spirit of the invention or the scope of the appended claims.

I claim:

1. A lighting apparatus adaptable to pet collars and leashes comprising:
a main body including at least one light source, at least one on/off switch, and at least one battery;
a substantially rigid strip of predetermined width with two ends in a first plane about 180 degrees apart with a central portion bowed away from said first plane and tangential to a second plane parallel to said first plane;
at least two means for removably securing said two ends in a first plane to at least one of a collar and a leash; and
a means for rotatably fastening said central portion to one surface of said main body in order to allow user to alter an aim of said light source.

2. The lighting apparatus according to claim 1, wherein said predetermined width is at least five millimeters and less than that of most common dog collars.

3. The lighting apparatus according to claim 1, wherein said means for rotatably fastening said central portion is a rivet-like fastener.

4. The lighting apparatus according to claim 1, wherein said means for rotatably fastening said central portion is a bolt and nut.

5. The lighting apparatus according to claim 1, wherein said rotatable fastening means includes a friction-inducing disc sandwiched between said main body and said central portion of said substantially rigid strip.

6. The lighting apparatus according to claim 3, wherein said rotatable fastening means includes a friction-inducing disc sandwiched between said main body and said central portion of said substantially rigid strip.

7. The lighting apparatus according to claim 1, wherein said at least two means for removably securing are strips of hook and loop fastener.

8. The lighting apparatus according to claim 1, wherein said at least two means for removably securing are plastic clips.

9. The lighting apparatus according to claim 1, wherein said light source is a pair of light-emitting diodes.

10. The lighting apparatus according to claim 1, wherein separation between said first plane and said second plane is at least one centimeter.
